(19) United States
(12) Patent Application Publication
(10) Pub. No.: US 2025/0359972 A1
(43) Pub. Date: Nov. 27, 2025

(54) DENTAL RETRACTOR CONFIGURED FOR CONTINUOUS FLUID REMOVAL

(71) Applicant: ISORETRACT, LLC, Midvale, UT (US)

(72) Inventor: Antonio Jacob HERRERA, Midvale, UT (US)

(21) Appl. No.: 19/181,159

(22) Filed: Apr. 16, 2025

Related U.S. Application Data
(60) Provisional application No. 63/650,260, filed on May 21, 2024.

(51) Int. Cl. A61C 17/10

(52) U.S. Cl. CPC A61C 17/10

(57) ABSTRACT

Disclosed are dental retractors configured to remove fluid from a patient's mouth during a dental procedure. The dental retractor may comprise a tongue holder having first and second arms extending opposite one another from the center of the mouth laterally past the teeth. The tongue holder may have a first half and a second half. The dental retractor may also comprise first and second mouth retractors, each mouth retractor pivotably connected to the first or second arm, the mouth retractors being connected by a dental bar.

### CROSS-REFERENCE TO RELATED APPLICATIONS

The present application incorporates by reference in its entirety and claims the benefit of U.S. Provisional Patent Application Ser. No. 63/650,260 filed on May 21, 2024.

### BACKGROUND

### Technical Field

This disclosure relates to dental retractors configured for use during a dental procedure.

### Related Technology

A dental retractor is a dental device that may be used during a dental procedure. Dental retractors may be configured to maintain a patient's mouth in an open position, providing the dental practitioner with an open field of view. These devices may be particularly useful for dental cleanings, installing braces, and dental surgery. Dental retractors may comprise cheek and lip retractors configured to pull the lips and cheeks away from the patient's teeth.

One problem faced by dental practitioners is to maintain the mouth free from excessive fluid and removing fluids in the mouth during the dental procedure. The mouth may be beneficially kept in a relatively dry state to prevent excess fluid from interfering with the dental procedure by, for example, obscuring the surfaces of a patient's mouth or causing discomfort to the patient during the procedure, as well as preventing other detriments. Additionally, fluids introduced to the mouth (e.g., cleaning fluids) may need to be removed periodically from the mouth during the dental procedure. During dental procedures removal of fluid is conventionally achieved by periodically introducing an aspirator into the mouth to pull fluid from the mouth, the patient closing their lips around the aspirator to create a vacuum within the mouth. However, traditional dental retractors prevent the patient from closing their lips about the aspirator to form a vacuum within the mouth.

Dental retractors remain underdeveloped and present opportunities exist for improving the experience of the patient during a dental procedure and for enabling the dental practitioner to efficiently perform procedures within the patient's mouth. Accordingly, there is a need for improved dental retractors within the dental device industry.

### SUMMARY

Disclosed are embodiments of a dental retractor for use during a dental procedure, the dental retractor comprising a tongue holder, first and second mouth retractors, and a dental bar. The tongue holder may include a tongue holder body configured to receive a tongue of a patient, a first arm extending from a first side of the tongue holder body, and a second arm extending from a second side of the tongue holder body opposite the first side. The first mouth retractor may be pivotably connected to the first arm of the tongue holder and the second mouth retractor may be pivotably connected to the second end of the tongue holder. The tongue holder may also be adjustable in an anterior-to-posterior direction relative to the first and second mouth retractors via connection slots formed on the surface of the first and second mouth retractors. The first and second mouth retractors may be pivotably connected to the dental bar. When the tongue holder body is disposed about a patient's tongue the first and second arms may be configured to extend from the tongue holder laterally beyond a patient's teeth. The tongue holder body may comprise a first portion and a second portion separated by a dividing slot, the first and second portions being connected by a flexible bridge. The flexible bridge may be disposed at or near an anterior end of the tongue holder body, such that the tongue holder body may be adjustable in width.

The dental retractor may be configured to be connected to a suction system to remove the fluid from a patient's mouth. The suction system may be connected to the dental retractor by suction tubing at tubing connections located at the ends of the first and second arms. The tubing connections may be connected to the tongue holder body by medial portions of the first and second arms. The first and second arms may comprise a suction lumen to provide fluid communication between the tubing connections and ports disposed on the tongue holder.

The first and second arms of the tongue holder may each comprise an orientation surface configured to position the tongue holder relative to the surface of a patient's teeth. A plane of the orientation surface may be positioned at an oblique angle relative to a central axis passing through a center of the tongue holder body, such that when the orientation surface is positioned adjacent the surface of a patient's teeth the anterior end of the tongue holder body is positioned below or inferior to the arms.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A illustrates a rear perspective view of an exemplary dental retractor.

FIGS. 1B-1C illustrate a rear and front view of an exemplary dental retractor, respectively.

FIGS. 2A-2B illustrate a top and bottom view of an exemplary dental retractor, respectively.

FIGS. 3A-3B illustrate a left and right view of an exemplary dental retractor, respectively.

FIGS. 4A-4B illustrate a top and bottom view of an exemplary tongue holder, respectively.

FIGS. 5A-5B illustrate a front and rear view of an exemplary tongue holder, respectively.

FIGS. 5C-5D illustrate a left and right view of an exemplary tongue holder, respectively.

FIG. 5E illustrates a left view of an exemplary tongue holder, showing a slot and suction lumen disposed within the tongue holder.

FIGS. 6A-6D illustrate a top, left, rear, and front view of an exemplary left mouth retractor, respectively.

FIGS. 7A-7B illustrate a front and rear view of an exemplary dental bar, respectively.

FIGS. 7C-7D illustrate a left and right view of an exemplary dental bar, respectively.

FIG. 8 illustrates a portion of an exemplary dental retractor, showing the pivotable connection between an exemplary left mouth retractor and dental bar.

FIG. 9A illustrates a perspective view of an exemplary left mouth retractor.

FIG. 9B illustrates a portion of an exemplary dental retractor, showing the pivotable connection between an exemplary tongue holder and right mouth retractor.

FIG. 9C illustrates a rear view of an exemplary dental retractor.

FIG. 10A illustrates a front perspective view of an exemplary dental retractor.

FIG. 10B illustrates a front view of an exemplary dental retractor.

FIG. 10C illustrates a rear view of an exemplary dental retractor.

FIG. 10D illustrates a rear perspective view of an exemplary dental retractor.

FIG. 11 illustrates a left view of an exemplary tongue holder.

FIG. 12 illustrates a left view of an exemplary left mouth retractor.

FIG. 13A illustrates a front perspective view of an embodiment of a dental retractor.

FIG. 13B illustrates a rear perspective view of an embodiment of a dental retractor.

FIG. 14A illustrates a top front perspective view of a tongue holder.

FIG. 14B illustrates a side perspective exploded view of the tongue holder of FIG. 14A.

FIG. 14C illustrates a bottom perspective exploded view of the tongue holder of FIG. 14A.

FIG. 15A illustrates another embodiment of a second half of a tongue holder.

FIG. 15B illustrates a perspective view of the second half of a tongue holder shown in FIG. 15A.

### DETAILED DESCRIPTION

Disclosed are embodiments of a dental retractor configured for use during a dental procedure. The dental retractor may be configured to pull and/or curl the lips and cheeks away from the teeth. The dental retractor may be advantageously attached to a suction system for continuously removing fluid from a patient's mouth during the dental procedure. This configuration beneficially removes the need for the dental practitioner to periodically and manually remove fluid from the patient's mouth. The configuration also ensures that the patient's mouth remains relatively dry, minimizing the spread or contamination of fluid in the patient's mouth.

As used herein, the following terms may have the following definitions:

The term “lateral” may refer to a location or direction towards the side of the body (e.g., the side of the mouth, or towards the cheek). The term “medial” may refer to a location or direction towards the center of the body (e.g., the center of the tongue).

The term “anterior” may refer to a location or direction towards the front of the body (e.g., the front of the mouth) or a forward-facing location. The term “posterior” may refer to a location or direction toward the back of the body (e.g., towards the throat of the mouth) or may refer to features in a location or direction opposite “anterior” features.

The term “superior” may refer to a location or direction towards the top of the body (e.g., the roof of the mouth). The term “inferior” may refer to a location or direction towards the bottom of the body (e.g., the floor of the mouth) or may refer to features in a location or direction opposite “superior” features.

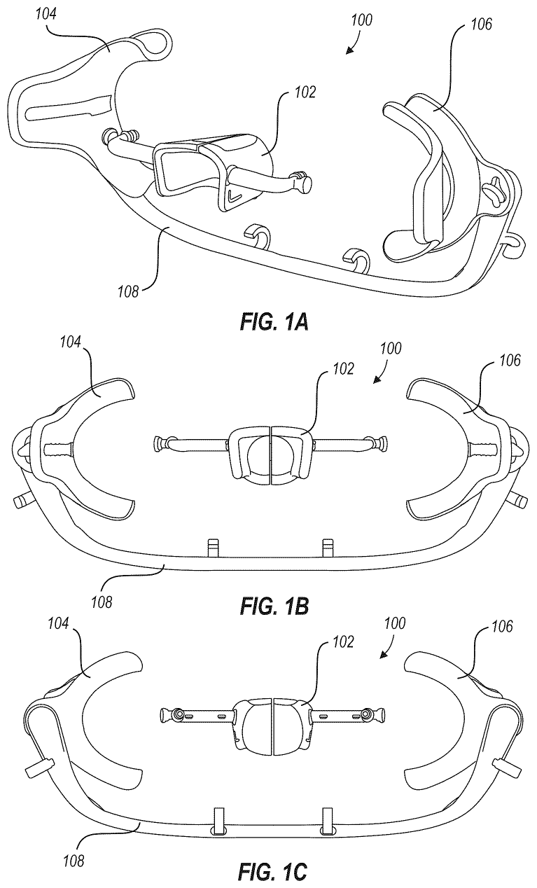

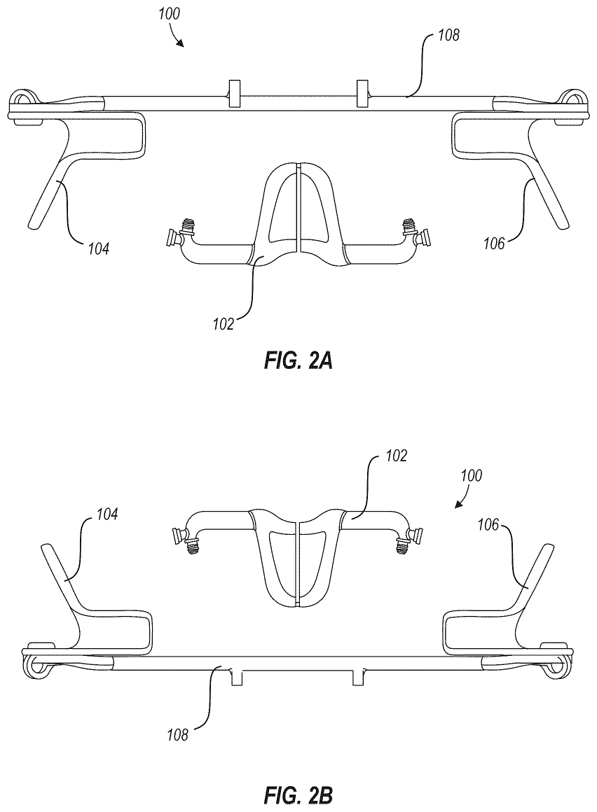

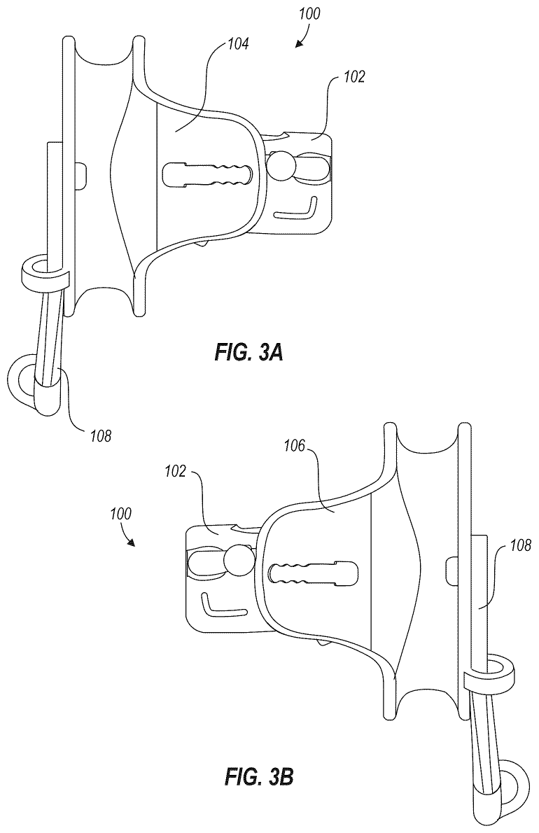

FIGS. 1A-1C, 2A-2B, and 3A-3B illustrate an exemplary embodiment of a dental retractor 100. The dental retractor 100 may comprise a tongue holder 102, a left mouth retractor 104, a right mouth retractor 106, and a dental bar 108. The tongue holder 102 is configured to be disposed about a patient's tongue. The left and right mouth retractors 104, 106 may be configured to receive a patient's lips and to pull, roll, or retract the lips outwards away from the teeth and gums and to maintain the patient's mouth in an open position during a dental procedure. The components of the dental retractor 100 (i.e., the tongue holder 102, the left and right mouth retractors 104, 106, and the dental bar 108) may comprise rounded edges so as to prevent irritation or harm to the surfaces of the mouth that could occur as a result of hard or sharp edges.

The components of the dental retractors of the present disclosure may be formed from additive manufacturing or extrusion molding processes. The dental retractor may comprise rigid or semi-rigid materials, including plastics (e.g., medical-grade plastics such as polypropylene, polyethylene, polycarbonate, polyetherimide, or polyetheretherketone), metals, rubbers (or other elastic materials), or composite materials. The materials of the dental retractor 100 may be sufficiently rigid to maintain their shape, but not so hard as to damage the patient's teeth. The dental retractor may be formed from materials that retain their shape after disinfection processes, such as cleaning in an autoclave, ultrasonic cleaning, cleaning in a dishwasher, or cleaning in boiling water.

For example, the dental retractors of the present disclosure can be manufactured using a polypropylene (PP) homopolymer or similar polymer or composite material. This material can exhibit a specific gravity in the range of about 0.88 to about 0.92 (e.g., about 0.90), ensuring lightweight properties. It can have a melt flow rate of about 4.5 g/10 min to about 5.5 g/10 min (e.g., about 5.00 g/10 min), facilitating case of molding. The tensile strength can range from about 4500 psi to about 5500 psi (e.g., about 5000 psi), providing adequate durability, while the tensile elongation exceeds about 10% (e.g., about >10%), offering flexibility. The material can have a deflection temperature of about 195° F. to about 215° F. (e.g., about 205° F.), ensuring thermal stability during use. The material can also have a SHORE D HARDNESS SCALE value of about 70 to about 90 (e.g., about 80), allowing the dental retractor to remain bendable but rigid enough to withstand the bite force of a patient. Specifically, the hardness of the material can be chosen to prevent the dental retractor from collapsing and halting the fluid extraction. The material used may also be ISO 10993 (10993-1/5/10/11) and USP compliant. Thus, the chosen material can meet standards for irritation, systemic toxicity, and cytotoxicity to ensure safe use inside the mouth of a patient. The dental retractors illustrated herein may include components that are made of the same material. For example, with the illustrated dental retractor 100, each of the tongue holder 102, left mouth retractor 104, right mouth retractor 106, and a dental bar 108 can be formed from the same material. Alternatively, one or more of the components of the dental retractor may be formed from different materials compared to one or more other components of the dental retractor.

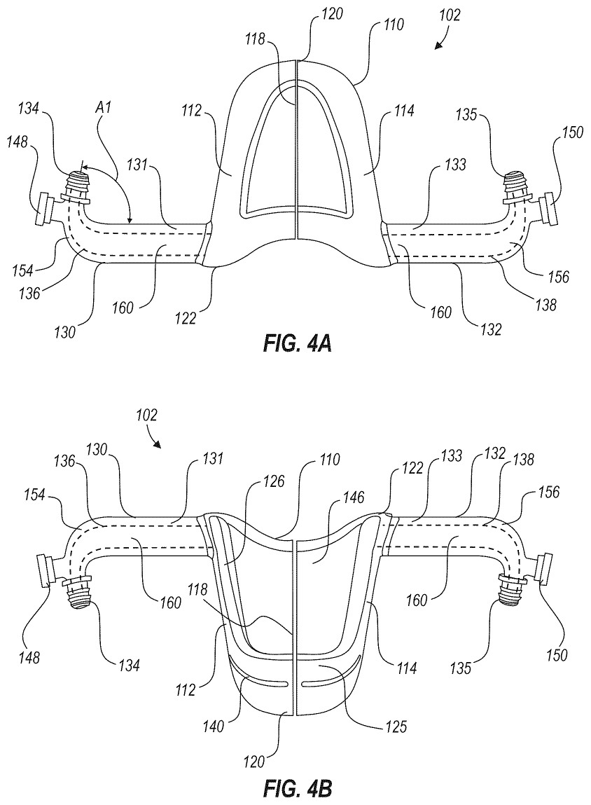

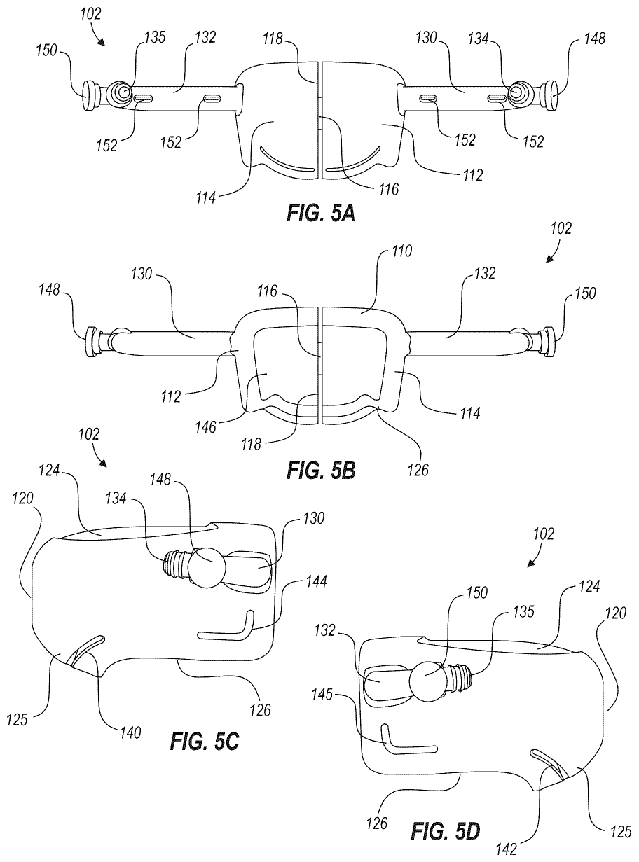

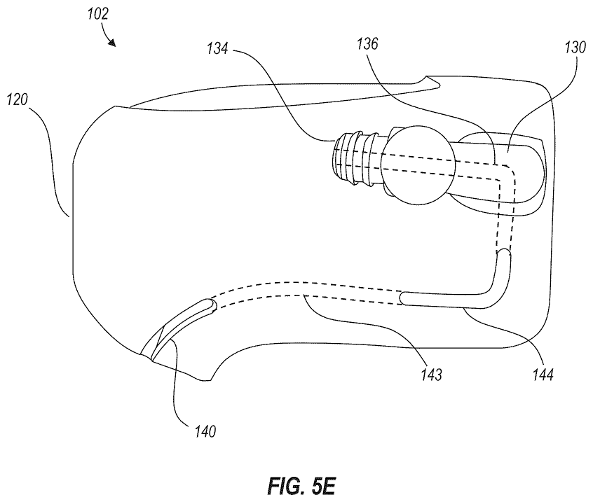

FIGS. 4A-4B and 5A-5D illustrate the exemplary tongue holder 102. The tongue holder 102 may include a tongue holder body 110 configured to receive a tongue of a patient. The tongue holder body 110 may have a generally cup-like shape, having an open posterior end 122 configured to receive the tongue of a patient and a closed anterior end 120 configured to interface with the anterior end of a patient's tongue. The tongue holder body 110 may be configured to cover at least a portion of the patient's tongue and to prevent the patient's tongue from interfering with the dental procedure. The tongue holder 102 may accomplish this by positioning the patient's tongue at the correct orientation and/or by protecting the patient's tongue from devices and materials used during the dental procedure. The tongue holder body 110 may comprise a first portion 112 at a left side of the tongue holder body and a second portion 114 at a right side of the tongue holder body 110. The first and second portions 112, 114 may be separated by a dividing slot 118, the first and second portions 112, 114 being connected by a bridge 116. The bridge 116 may be disposed at or near the anterior end 120 of the tongue holder body 110, but may additionally or alternatively be disposed at other portions of the tongue holder body 110, such as the superior portion 124 or the inferior portion 125. The bridge 116 may be relatively thin and flexible, enabling the bridge 116 to flex and the first and second portions 112, 114 to pivot relative to one another. For example, the first and second portions 112, 114 of the tongue holder body 110 may be connected by a bridge 116 disposed at the anterior end 120 of the tongue holder body 110, such that the first and second portions 112, 114 may pivot and/or flex relative to one another and allow the width of the tongue holder body 110 to be adjustable at a posterior end 122. In this manner, the width of the dividing slot 118 and the tongue holder body 110 may be adjustable for accommodating varying widths of a tongue of a patient. The inferior portion 125 of the tongue holder body 110 may comprise a cutout 126. The cutout 126 may be configured to accommodate the bottom of a patient's tongue, including the lingual frenulum of the tongue. Thus, the inferior portion 125 may extend only partly along the bottom of the tongue holder body 110.

The tongue holder 102 may comprise a left or first arm 130 extending from the first portion 112 (left side) of the tongue holder body 110 and a right or second arm 132 extending from the second portion 114 (right side) of the tongue holder body 110 opposite the first arm 130. The first and second arms 130, 132 may extend laterally from the tongue holder body 110. The first and second arms 130, 132 may comprise medial portions 131, 133 connected directly to the first and second portions 112, 114, respectively. The arms 13, 132 may be integrally formed with the tongue holder body 110, such that the tongue holder 102 comprises a single piece. In other embodiments, the arms 130, 132 may be detachable from the tongue holder body 110.

The first and second arms 130, 132 may also comprise first and second tubing connections 134, 135, respectively, for connecting suction tubing to the tongue holder 102. For example, suction tubing comprising soft or flexible tubing, such as silicone tubing or other tubing configured for use in a dental procedure, may be connected to the tongue holder 102 at the first and/or second tubing connections 134, 135 to provide suction to the surfaces of the tongue holder 102. The first and second tubing connections 134, 135 may include a barbed surface, or other surface, configured to secure suction tubing to the first and second tubing connections 134, 135. The first and second tubing connections 134, 135 may extend at an angle A1 from corresponding medial portions 131, 133, such that the tubing connections 134, 135 are oriented in an anterior-facing direction. For example, the first and second connections 134, 135 may extend at a 75 to 105 degree angle (e.g., 90 degree angle) from the medial portions 131, 133. The first and second tubing connections 134, 135 may be connected to the medial portions 131, 133 of the first and second arms by bends 154, 156, orient the tubing connections 134, 135 at the angle A1. This configuration reduces or prevents the suction tubing from having a bend or kink as the suction tubing extends from the tongue holder 102 out of the mouth, and thus improves delivery of suction to the tongue holder 102.

The first and second arms 130, 132 may comprise a first and second suction lumens 136, 138 disposed within the arms 130, 132 (as shown in dotted lines in FIGS. 4A and 4B). The suction lumens 136, 138 may connect the tubing connections 134, 135 with one or more ports disposed on an exterior surface of the tongue holder 102, such that the suction lumens and the one or more ports may be in fluid communication with the tubing connections 134, 135 and subject to suction provided by a suction system. The tongue holder 102 may be disposed over the tongue during the dental procedure, during which the tongue may be disposed behind the teeth, positioning the tongue holder 102 towards the back of the mouth. Fluid (e.g., saliva, water, or dental cleaning fluids) may then beneficially be collected through the one or more ports, maintaining the mouth in a relatively dry state and removing the need for the dental practitioner to periodically remove fluid, the fluid being removed by the dental retractor and suction system automatically and/or continuously.

The one or more ports may be disposed on the first and second portions 112, 114 of the tongue holder body 110. For example, the one or more ports may include a first anterior port 140, a second anterior port 142, and with reference to the views of FIGS. 5C and 5D, a first posterior port 144, and a second posterior port 145, located on lateral portions of the first and second portions 112, 114. The one or more ports may be connected to the suction lumens 136, 138 via slots 143 (shown in FIG. 5E) formed as channels in the wall of the first and second portions 112, 114 and configured to provide fluid communication between the one or more ports and the suction lumens 136, 138. The presence of the slots 143 provides that the tongue holder body 110 is at least partially hollow. The one or more ports may not be formed on the interior surface 146 of the tongue holder body 110 so as to prevent suction from being directly applied to any portion of the patient's tongue in contact with the tongue holder body 110, including the anterior portions of the patient's tongue.

Additionally, or alternatively, the one or more ports may be disposed on an external surface of the first and/or second arms 130, 132. The one or more ports may be disposed on a posterior surface of the first and/or second arms 130, 132 or, as illustrated in FIG. 5A, the one or ports may be disposed on an anterior surface of the first and/or second arms 130, 132, such as ports 152, disposed on the anterior surface of first and second arms 130, 132.

The medial portions 131, 133 of the first and second arms 130, 132 may extend from the tongue holder body 110 such that the medial portions 131, 133 extend laterally beyond a patient's teeth. That is, when the tongue holder is disposed about a patient's tongue the medial portions 131, 133 of the first and second arms 130, 132 may extend from the tongue holder body 110 laterally past the teeth (e.g., the molars or premolars) to a point between the teeth and the checks of the patient. The tongue holder 102, including the first and second arms 130, 132, may comprise a sufficiently hard or rigid material (e.g., a hard plastic) such that the medial portions 131, 133 extending beyond the teeth of a patient prevent a patient from collapsing the suction lumens 136, 138 when closing their jaw. That is, because the arms 130, 132 of the tongue holder 102 comprise a sufficiently hard material, the patient is prevented from completely closing their jaw and cutting off fluid communication between the suction lumen and a suction system. For example, the arms 130, 132 of the tongue holder 102 can have a SHORE D HARDNESS SCALE value of about 70 to about 90 (e.g., about 80), which has been found to provide effective structural rigidity to prevent the patient from closing off suction when biting, without being overly hard or rigid given the intended use in the mouths of patients.

The first and second arms 130, 132 may be configured to be positioned proximal (posterior) of the molars of the patient to correctly orient the tongue holder 102. In this manner, the one or more ports may be positioned proximal of the salivary glands where fluid is secreted into the mouth. This orientation also enables the one or more ports to be located near parts of the mouth where fluid is likely to collect when the patient is lying in a supine position.

The first and/or second arms 130, 132 may comprise an orientation surface 160 (see the views of FIGS. 4A and 4B). The orientation surface 160 may comprise a flat surface and may be disposed on a superior surface and/or an inferior surface of the first and/or second arms 130, 132. In instances wherein orientation surfaces 160 are placed on both the superior surface and the inferior surface, the orientation surfaces 160 may be parallel to one another. The orientation surface 160 is configured such that as the patient closes his/her jaw, the first and/or second arms 130, 132 are positioned or rotated to bring the orientation surface into contact with a surface (e.g., the crown) of the teeth, the teeth (e.g., molars or premolars) clamping down on the arms to secure the orientation of the tongue holder 102 within the mouth relative to the surfaces of the teeth. The orientation surfaces 160 thus help prevent the tongue holder 102 from rotating while the patient's jaw is closed. The height of the arms 130, 132 may be smaller in a direction perpendicular to the orientation surface(s) 160 when compared with a thickness of the arms parallel to the orientation surface(s) 160 to facilitate rotation of the first and/or second arms 130, 132 until the orientation surface(s) are aligned with and come into contact with the crown of the teeth. The tubing connections 134, 135 may extend from the first and second arms 130, 132 in a direction generally parallel to the orientation surface(s) 160 such that the tubing connections 134, 135 are angled directly out of the patient's mouth when orientation surface(s) 160 are aligned with the patient's teeth.

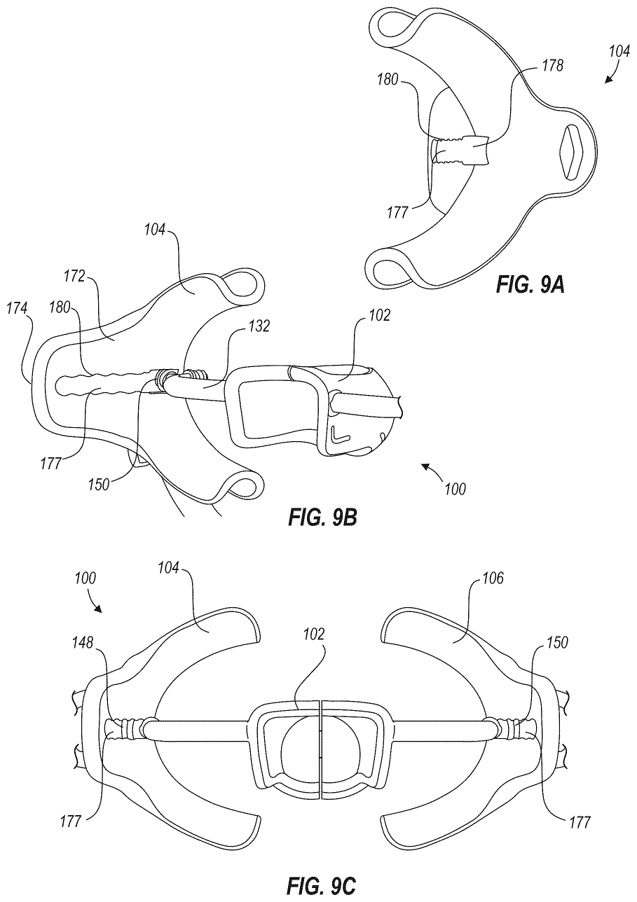

A first connector flange 148 may extend from the first arm 130 and a second connector flange 150 may extend from the second arm 132. The first and second connector flanges 148, 150 may be configured to connect to the first and second mouth retractors 104, 106. The first and second connector flanges 148, 150 may also have a round profile to enable the tongue holder 102 to be pivotably connected to the first and second mouth retractors 104, 106, the connection being more fully described below in relation to FIGS. 9A-9C.

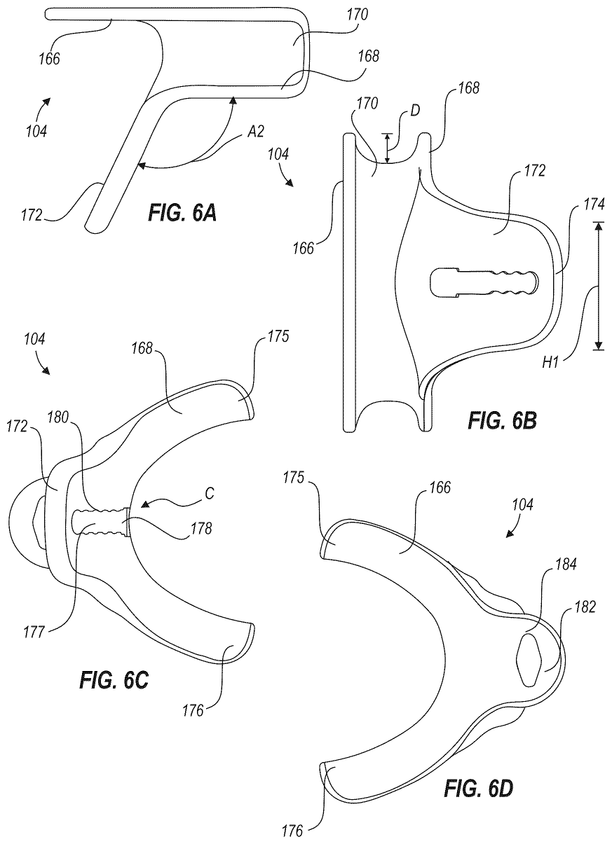

FIGS. 6A-6D illustrate the example left mouth retractor 104. While FIGS. 6A-6D and the following description are directed to the left mouth retractor 104, it will be understood that the right mouth retractor 106 may contain all the same features, the right mouth retractor 106 being a mirror view of the left mouth retractor 104. The left mouth retractor 104 may comprise an anterior wall 166 and a posterior wall 168, defining therebetween a groove 170, the walls 166, 168 and groove 170 being configured to receive the lips of a patient's mouth and pull the lips and/or cheeks away from the patient's teeth and gums to provide a dental practitioner a clear view and ample space with which to perform a dental procedure. The groove 170 may have a c-shaped or generally curving profile and may extend between a superior end 175 to an inferior end 176 with a curvature C configured to provide a wide field of view to the dental practitioner. The curvature of the left mouth retractor 104 and the depth D of the groove 170 may be sufficiently large so as to prevent a patient's lips from easily exiting the groove 170, such that the mouth retractor may securely pull the lips and cheeks away from the patient's teeth throughout the dental procedure, but sufficiently small to prevent excessive discomfort to the patient.

The left mouth retractor 104 may comprise a check retractor 172 configured to push the cheeks outward away from the teeth and prevent the cheeks from interfering with the dental procedure. The cheek retractor 172 may extend from the posterior wall 168 at an angle A2. In some embodiments, angle A2 between the check retractor and the posterior wall 168 may be approximately 90 degrees. In other embodiments, the angle A2 between the check retractor and the posterior wall 168 may be an oblique angle between approximately 90 degrees and approximately 135 degrees. A manufacturer can vary angle A2 to ensure that the check retractor effectively presses portions of the patient's mouth (such as the buccal mucosa) away from the operating area provided by the dental retractors of the present disclosure.

The height H1 of the check retractor 172 may taper from the posterior wall 168 to a posterior end 174. The tapering height may be configured to approximate the taper of a patient's mouth from the opening of the mouth toward the patient's throat. The cheek retractor 172 may also be sufficiently short (as measured from the posterior wall 168 to the distal end 174 of the check retractor 172) so as to prevent the cheek retractor 172 from rubbing up against or contacting the bony portions of the patient's jaw. The left mouth retractor 104 may also comprise a connection tab 182 extending from the anterior wall 166, the connection tab 182 including an opening 184 configured to receive a knob 190 of the dental bar to form a pivotable connection, described in greater detail below. A healthcare provider will appreciate the height H1 of the cheek retractor and its ability to retain more of the patient's mouth (such as the buccal mucosa) than smaller alternatives.

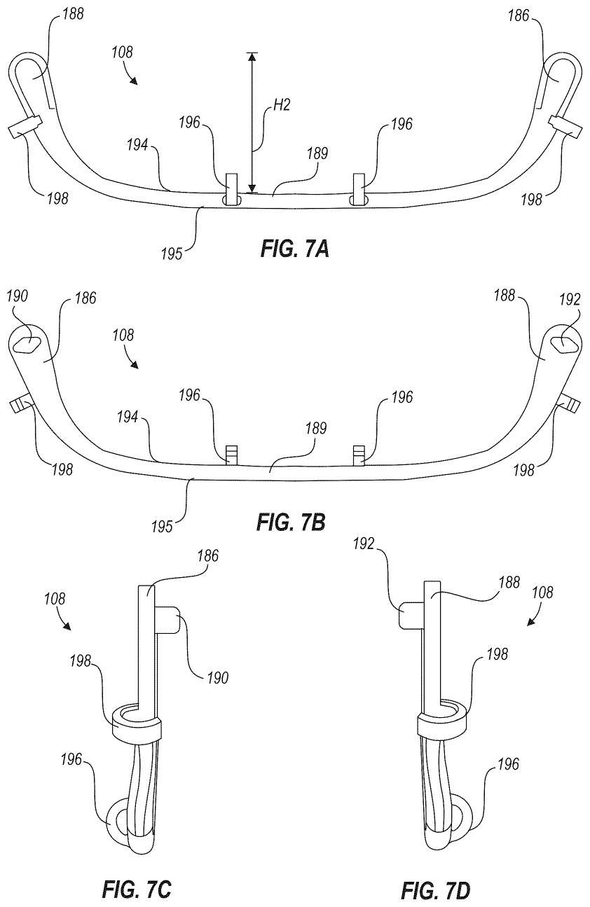

FIGS. 7A-7D illustrate an exemplary dental bar 108 configured to be connected to the left and right mouth retractors 104, 106. The dental bar 108 may comprise an elongated member that curves upwards at the first and second ends 186, 188. The height H2 of the first and second ends 186, 188 above a middle portion 189 of the dental bar 108 may be sufficient to allow the middle portion 189 to descend below a patient's chin when the mouth retractors 104, 106 are connected to the dental bar 108 and inserted into the patient's mouth. As illustrated by FIGS. 7C-7D, the middle portion 189 of the dental bar 108 may curve forward from the first and second ends 186, 188, which may prevent the dental bar 108 from agitatedly rubbing up against the patient's face.

The dental bar 108 may comprise a plurality of clips, such as medial clips 196 and lateral clips 198, configured to receive and secure suction tubing connected to the tongue holder 102 to the dental retractor 100. The lateral and medial clips may extend in opposite directions or in directions towards opposite sides of the dental bar. For example, the lateral clips 198 located near the first and second ends 186, 188 may extend towards the lower surface 195 of the dental bar 108. Lateral clips 198 having this configuration enable the suction tubing to be pulled away from the teeth as the suction tubing exits the mouth of a patient, maintaining a clear field of view for the dental practitioner and preventing the suction tubing from interfering with the dental procedure. After the suction tubing is secured to the lateral clips 198, the suction tubing may be secured to the medial clips 196. The medial clips 196 may extend towards the upper surface 194 of the dental bar, the upper surface 194 being opposite the lower surface 195. In this manner, the clips 196, 198 beneficially place the suction tubing in tension, securing the suction tubing to the dental bar 108 and preventing the suction tubing from moving during the procedure.

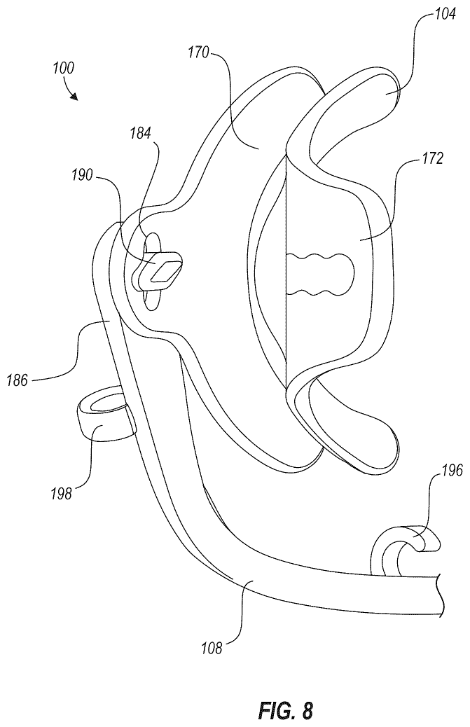

The dental bar 108 may comprise knobs 190, 192, located at the first and second ends 186, 188. Knob 190 may be configured to be received by the opening 184 of the connection tab 182 of the left mouth retractor 104, with knob 192 being configured to be received by a corresponding opening of the right mouth retractor 106. FIG. 8 illustrates a portion of the dental retractor 100, including the connection between the left mouth retractor 104 and the first end 186 of the dental bar 108. The knob 190 may have a generally oblong shape, such that when the knob 190 passes through the opening 184 and is rotated relative to the left mouth retractor 104 the knob 190 and first end 186 of the dental bar interlock with the opening 184 and connection tab 182 of the left mouth retractor 104, preventing the first end 186 from separating from the left mouth retractor 104. The opening 184 and the knob 190 may be oriented relative to one another such that the connection is in the interlocked position during normal use of the dental retractor 104. In other embodiments, the dental bar 108 may be pivotably connected to the left mouth retractor 104 via mechanism other than an opening 184 and knob 190 connection. For example, the pivotable connection between the dental bar 108 and left or right mouth retractors 104, 106 may comprise a hinged connection, a magnetic connection, or other pivotable connection.

FIGS. 9A-9C illustrate the left and right mouth retractors 104, 106 and their corresponding connections with the tongue holder 102. The left and right mouth retractors 104, 106 may comprise a connection slot 177 comprising a groove 170 formed in the surface of the check retractor 172 extending from a slot entry 178 posteriorly along the cheek retractor 172 and configured to receive a first or second connector flange 148, 150 to form a connection with the left or right mouth retractors 104, 106. The connection between the tongue holder 102 and the first and second mouth retractors 104, 106 may comprise a pivotable connection, the first and second connector flanges 148, 150 having a circular or round profile to enable rotation of the tongue holder 102 relative to the left and right mouth retractors 104, 106. The pivotable connection may enable the patient to orient the tongue in a position that is comfortable to the patient while continuing to provide the benefits of continuously fluid removal. The pivotable connection may also enable the patient to move the tongue in a superior-to-inferior direction while wearing the tongue holder 102 to enable the dental practitioner to access the surfaces of the teeth closest to the tongue, either above or below the tongue.

The tongue holder 102 may also be adjustable in an anterior-to-posterior direction within the connection slot 177. The anterior-to-posterior adjustability of the tongue holder 102 may enable the dental retractor 100 to accommodate mouths of varying sizes according to the needs of the patient and may also be used to provide fine adjustment of the distance between the lips and the teeth. To form the pivotable connection, a first or second connector flange 148, 150 is inserted through the slot entry 178 of a corresponding mouth retractor 104 or 106 and slid posteriorly to the desired position. The connection slot 177 may comprise ridges 180 formed on the edges of the connection slot 177 configured to grip the first or second connector flange 148, 150 and secure the tongue holder 102 in the desired position. The ridges 180 may frictionally engage the first or second connector flanges 148, 150, allowing the connector flanges 148, 150 to rotate relative to the connection slot 177 and enabling the tongue holder 102 to be moved between positions along the connection slot 177. The ridges 180 may also engage the connector flanges 148, 150 with sufficient strength such that the patient may not inadvertently change the position of the tongue holder 102 along the connection slot 177 by pushing against the tongue holder body 110 with their tongue.

The anterior-to-posterior adjustability may also provide adjustment of the distance between the check retractors 172 of the left and right mouth retractors 104, 106. For example, by moving the position of the pivotable connection between the tongue holder 102 and the first or second mouth retractor 104, 106 in a posterior direction the check retractor 172 of the left mouth retractor 104 may be brought closer to the cheek retractor of the right mouth retractor 106, the first and/or second mouth retractor 104, 106 pivoting about the lips to pull the lips further away from the teeth. By moving the tongue holder 102 in an anterior direction, an opposite effect may be introduced, increasing the distance between the cheek retractors 172.

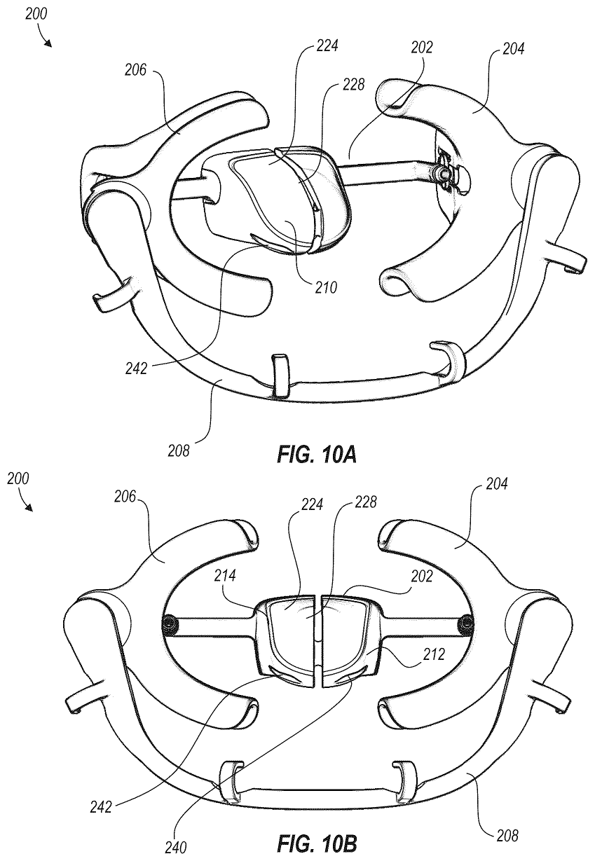

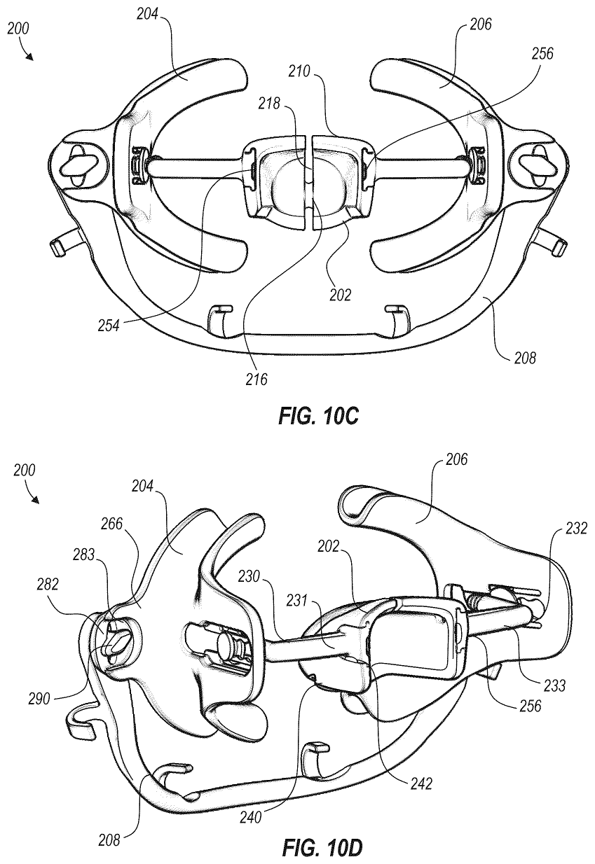

FIGS. 10A-10D illustrate another embodiment of a dental retractor 200 that may include any of the features or components of dental retractor 100. The dental retractor 200 may comprise similar components as dental retractor 100, including a tongue holder 202, left and right mouth retractors 204, 206, and a dental bar 208. The tongue holder body 210 may comprise first and second portions 212, 214 separated by a dividing slot 218 along a substantial length of the tongue holder body 210, the first and second portions 212, 214 being connected by a flexible bridge 216. The dental retractor 200 may comprise a slanted surface 228 disposed on the superior surface 224 near the anterior end 220 of the tongue holder body 210. The slanted surface 228 pushes the tip of the patient's tongue downwards and beneficially reduces the size of the tongue holder body and positions the tongue optimally to enable a dental practitioner to work within the mouth, leaving more room for the dental practitioner and ensuring that the tongue holder 202 is not so large as to impede the work of the dental practitioner.

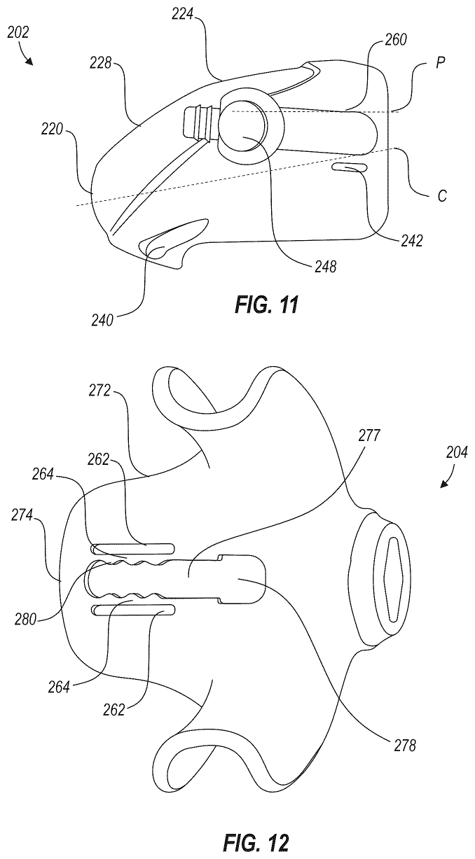

FIG. 11 illustrates the tongue holder 202, showing that the tongue holder 202 may be configured to place the anterior end 220 of the tongue holder body 210 at a point below or inferior to the first and second arms 230, 232, the slanted surface 228 being formed at an angle relative to a central axis C passing through the center of the tongue holder body 210. An orientation surface 260 of the first or second arms 230, 232 may comprise a plane P, the plane P being set at an oblique angle relative to the central axis C. The oblique angle between the plane P and central axis may be set such that the anterior end 220 is optimally placed when the orientation surface(s) 260 are brought into proximity with the crown of the teeth and aligned with the teeth. For example, the angle between the plane P and the central axis C may be in a range between greater than zero degrees and approximately 45 degrees, or between approximately 10 degrees and approximately 35 degrees, or between approximately 15 degrees and approximately 30 degrees, or in a range having any two of the foregoing as endpoints.

FIG. 12 illustrates a left mouth retractor 204 similar to left mouth retractor 104 described above, with a right mouth retractor 206 also being a mirror image of the left mouth retractor 204. The left mouth retractor 204 may comprise a groove 170 configured to pull the lips of the patient away from the teeth, a cheek retractor 272 extending to a tapered posterior end 274, and a connection slot 277 including a slot entry 278 and ridges 280 formed in the slot edges 264 for positioning the left mouth retractor 204. Entry 278 can be defined by the groove (see groove 170) of mouth retractor 204. This can mean that entry 278 extends into the groove of mouth retractor 204.

As shown in FIG. 12, the left mouth retractor may also include flexion slots 262 disposed above and/or below connection slot 277. The flexion slots 262 enable the slot edges 264 to bend and flex when positioning the connector flange 248 in connection slot 277 and enable the tongue holder to move minimally in a medial-to-lateral direction. The bending and flexing motion of the slot edges 264 facilitates the placement of the connector flange 248 in the connection slot 277 and improves the comfort of the patient.

The left mouth retractor 204 may also comprise a recess 283 (see FIGS. 10C-10D) formed in the connection tab 282. The recess 283 is configured to receive the knob 290, such that the knob 290 does not extend posteriorly beyond the posterior surface of the anterior wall 266. In this manner, the recess 283 may beneficially prevent the knob 290 from irritating and rubbing against the patient's cheek during rotation between the mouth retractors 204, 206 and the dental bar 208.

Similar to dental retractor 100, the dental retractor 200 may comprise one or more ports formed on the surface of the tongue holder body 210 or along the surfaces of the first and second arms 230, 232. For example, the one or more ports may include a first anterior port 240, a second anterior port 242, and posterior ports 242, located on lateral portions of the tongue holder body 210. The one or more ports may be connected to the suction lumens disposed within the arms 230, 232 via slots formed in the wall of the tongue holder body 210 configured to provide fluid communication between the one or more ports and the suction lumens, similar to the slots of dental retractor 100. The one or more ports may also comprise posterior ports 254, 256 located on a posterior surface of the tongue holder body.

The size of the components of the dental retractors 100 and 200 may vary depending on the size and age of the patient. The following exemplary features may be dimensioned to accommodate patients of differing sizes. Although the examples given refer to features of the dental retractor 200, one skilled in the art would understand that the same or similar features of the dental retractor 100 may be similarly proportioned. For example, the tongue holder 202, left and right mouth retractors 204, 206, and dental bar 208 may be made to fit an adult or to fit a child. The dental retractor 200 may be provided with multiple dental bars 208 of varying widths to accommodate mouths of different sizes. The length of the first and second arms 230, 232 may vary to accommodate the varying widths of patients' mouths. The length of the first and second arms 230, 232 may vary at the medial portions 231, 233 of the first and second arms 230, 232. For example, the length of medial portions 231, 233 of the first and second arms 230, 232 may be relatively short to accommodate the mouth of a child or may be relatively long to accommodate the mouth of an adult. The size of the tongue holder body 210 may also vary in size (e.g., width, height, and/or length) to accommodate the varying size of patients' mouths and tongues. The components may be interchangeable with smaller or larger components to enable the dental retractor 200 to be assembled to accommodate the size and form of a patient's mouth.

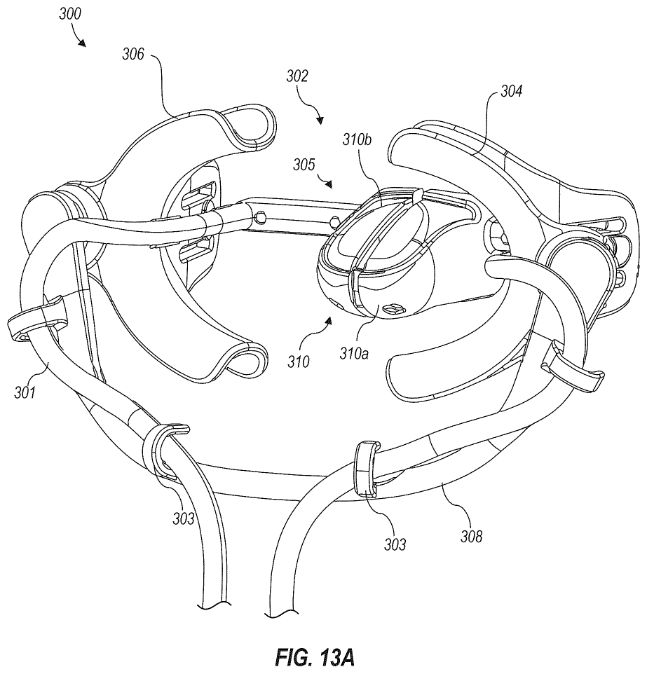

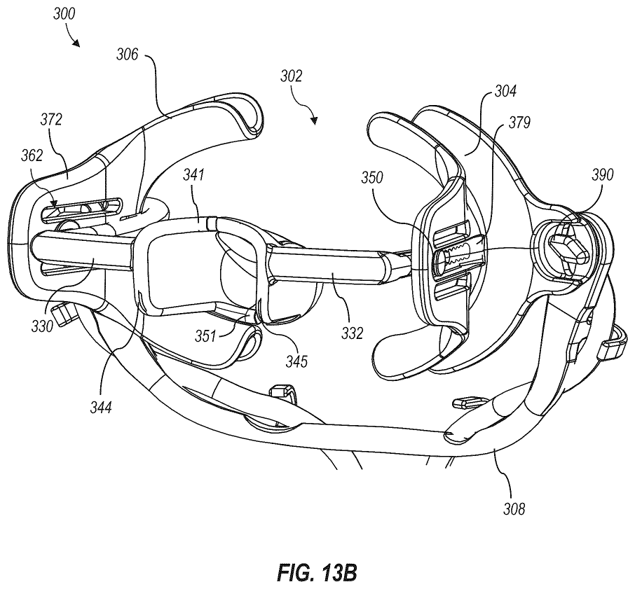

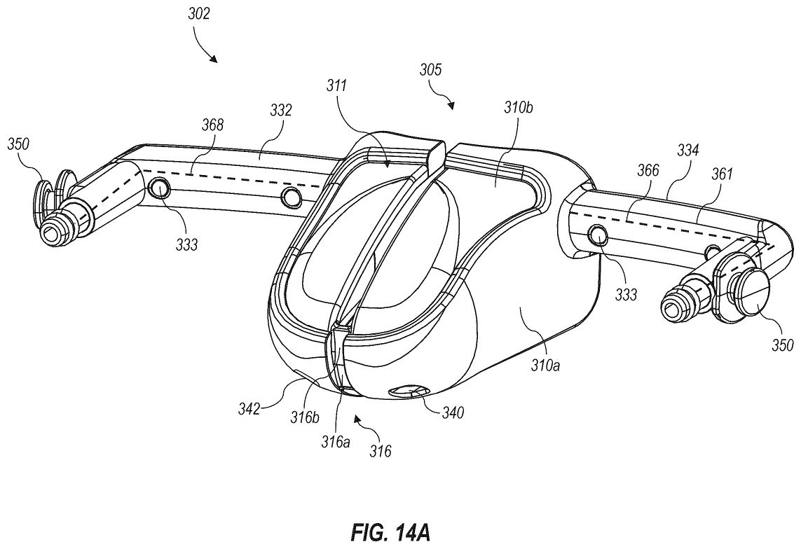

FIGS. 13A and 13B illustrate a third embodiment of a dental retractor of the present disclosure, specifically dental retractor 300. The dental retractor 300 can have any components, characteristics, or features disclosed regarding dental retractors 100 and 200. Similarly, dental retractors 100 or 200 can have any of the components, characteristics, or features of the other embodiments of dental retractors, such as dental retractors 300, disclosed herein.

FIG. 13A illustrates a front perspective view of the dental retractor 300. Dental retractor 300 can include tongue holder 302, mouth retractor 304 and 306, dental bar 308, and tubing 301. Tubing 301 can be formed from a flexible, resilient, stretchable, and compressible material. In at least one embodiment, tubing 301 can be formed from silicon. Tubing 301 can have an inner diameter of less than ¼ inch, about ¼ inch, about ⅜ inch, about ½ inch, about 1 inch, or more than 1 inch. Tubing 301 can have a SHORE A HARDNESS value of about 50 to about 70. For example, about 55, about 60, or about 65. Tubing 301 can selectively couple to the tongue holder 302 to facilitate the continuous fluid flow from the tongue holder 302 to the tubing 301. Tubing can also couple with dental bar 308 using one or more hooks 303 that extend from the dental bar 308. Tongue holder 302 can be a multipart tongue holder 302 having a first half 310a and a second half 310b. First half 310a can selectively receive second half 310b within the bounds defined by first half 310a. First half 310a and second half 310b can define tongue body 310. A healthcare provider can use tongue holder 302 within dental retractors 100 and 200. Similarly, a healthcare provider can use any component of dental retractors 100 and 200 with the dental retractor 300.

FIG. 13A also illustrates the sloped or angled nature of tongue holder 302 (see also FIG. 10A, slanted surface 228). The top portion 305 of the tongue holder body 310 can be sloped forward and downwards towards the bottom of a patient's mouth. This sloped or angled nature provides healthcare providers with more access to a patient's mouth when using the dental retractor 300.

FIG. 13B illustrates a rear perspective view of the dental retractor 300. As shown, dental bar 308 can selectively couple to mouth retractors 304 by way of knob 390. Similarly, a user or provider can selectively couple mouth retractor 306 to dental bar 308 by way of a knob. Mouth retractor 304 can selectively engage with tongue holder 302 using connector flange 350, similar to connector flange 248. A check retractor of the present disclosure defines connection slot 379. Tongue holder 302 can also secure to mouth retractor 306 via a connection slot defined by check retractor 372. A manufacturer may include one or more flexion slot 362 that flanks a connection slot. Flexion slot 362 enables the flex and mobility of a connection slot. For example, a healthcare provider using a dental retractor 300 can use a flexion slot to more easily adjust the position of a connector flange within a connection slot. Furthermore, flexion slot 362 helps keep a connector flange in a fixed position within the connection slot.

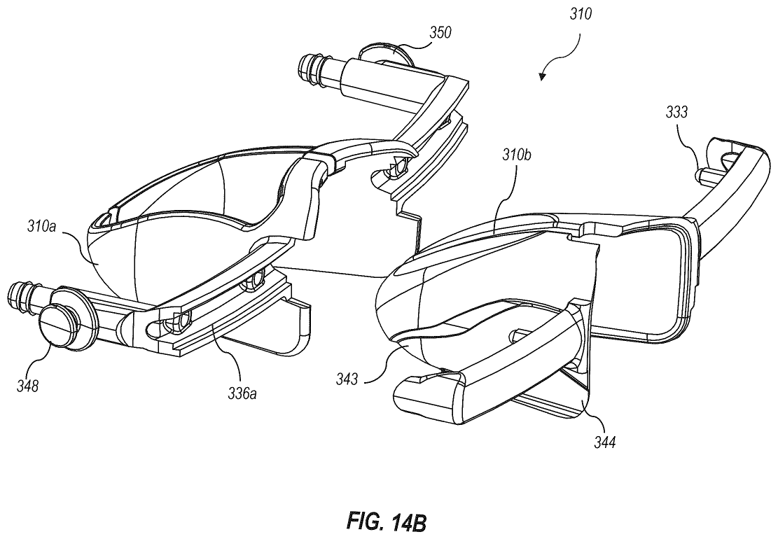

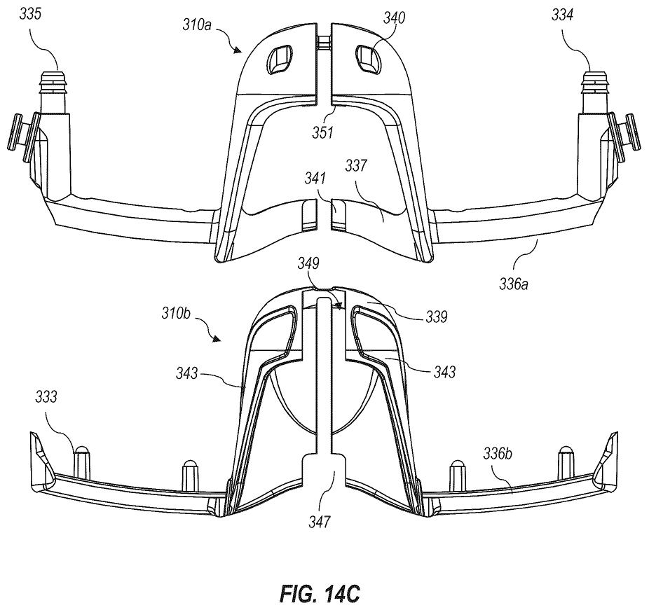

FIG. 13B also shows tongue holder 302, which has a first arm 330 and a second arm 332. First arm 330 and second arm 332 can be defined by the first half and second half of tongue holder 302 (this is shown in detail in FIG. 14B). Connector flange 350 is part of or disposed on second arm 332. Similarly, another connector flange can be a part of or disposed on first arm 330. The connector flange 350 is generally circular, allowing the tongue holder 302 to rotate even when secured to the check retractors. A user will appreciate that this rotation allows further adjustability and usability with a variety of mouth sizes.

FIG. 13B also shows an anterior key 351 and a posterior key 341. Anterior key 351 and posterior key 341 can protrude outward from the first half of a tongue holder to engage with the second half of a tongue holder of the present disclosure. Accordingly, the anterior key 351 and the posterior key 341 can assist in keeping the first half engaged with the second half of the tongue holder 302. The two-half design of the tongue holder 302 allows for additional suction in the spaces where the two halves meet or touch. Thus, including anterior key 351 and posterior key 341 allows a majority of the two halves to still be separate from each other (i.e., not adhered or coupled together), increasing the overall suction provided and ensuring the two halves do not shift relative to each other.

FIG. 13B illustrates a first posterior port 344 and a second posterior port 345. The posterior ports 344 and 345 can be in fluid communication with the suction lumen 366 (defined by channels 336a and 336b, See FIG. 14C). Posterior ports 344 and 345 can fluidly connect to suction lumen 366 by way of slot 343 (shown in FIG. 14B). Thus, posterior ports 344 and 345 enable tongue holder 302 to aid in the evacuation of fluid from a patient's mouth.

FIG. 14A illustrates a top front perspective view of tongue holder 302. As previously discussed, tongue holder 302 can have a tongue holder body 310, a first arm 330, and a second arm 332. Tongue holder 302 is a two-piece or multipart tongue holder, defined by the first half 310a and the second half 310b. First half 310a and second half 310b are secured together by one or more pins 333. Pins 333 are a part of or disposed on the second half 310b. Pins 333 pass through apertures defined by first half 310a, specifically on or near the first arm 330 and second arm 332. A manufacturer can ultrasonically weld, melt, or secure via heating pins 333 into the apertures they pass through. This securing process rigidly secures the first half 310a to the second half 310b. In at least one embodiment, a manufacturer may secure the first half 310a to the second half 310b solely through the pins without any additional securing features. Alternatively, keys 351 and 341 may act as indexes or guides to ensure the remaining portions of tongue holder 302 stay aligned in addition to the secured pins.

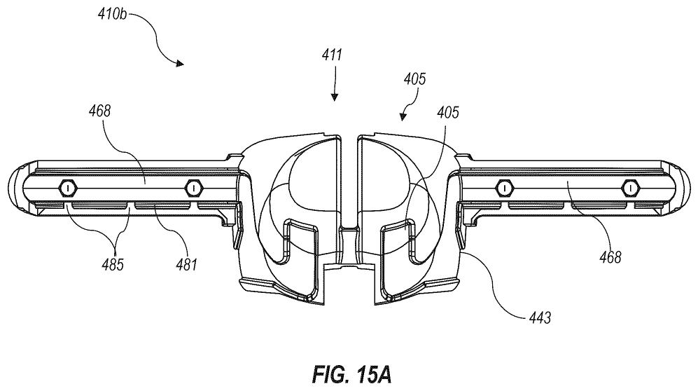

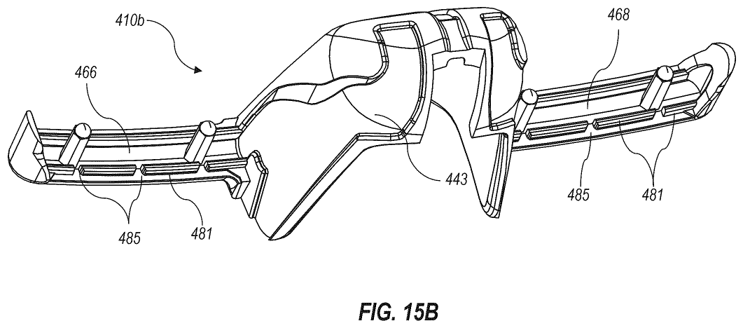

FIG. 14A shows zone 311. Zone 311 is defined by the top portion 305 of tongue holder 302. Zone 311 can be a zone of suction, meaning the area of joinder or abutment between the first half 310a and the second half 310b can facilitate fluid evacuation. In another embodiment, additional or alternative ports can be included in zone 311 by the expansion of slot 343 (see FIG. 15A). Additionally, in yet another embodiment, the points of joinder or abutment of the first half 310a and second half 310b along the first arm 330 and second arm 332 can constitute a port or area of suction. For example, if the posterior ports become occluded or blocked, the points of joinder or abutment 361 between the first and second halves, along the first and second arms, can facilitate the evacuation of fluid. In at least one case, the amount of suction provided by the joiner area is less than that of a posterior or an anterior port. This, again, is an advantageous benefit of the two-part design of the present disclosure, as any abutment or point of joiner between the first and second halves can act as a port or zone of suction.

FIG. 14A also illustrates the first anterior port 340 and the second anterior port 342. As with the posterior ports, anterior ports 340 and 342 can communicate fluidly with slot 343 and suction lumens 366. A manufacturer can position anterior ports 340 and 342 so that they do not contact areas of the mouth with bodily anatomy that are prone to easily clogging or blocking the ports. For example, anterior ports 340 and 342 can be positioned to sit right below the bottom teeth of a patient.

FIG. 14A also shows bridge 316, which is defined by bridges 316a and 316b. Bridge 316a can act as a hinge joint for the first half 310a, while bridge 316b can act as a hinge joint for the second half 310a. Bridge 316 enables a healthcare provider to adjust the overall width of tongue holder 302. The healthcare provider will appreciate that this expansion and contraction allow tongue holder 302 to be more easily secured to cheek retractors of the present disclosure, as connector flanges 348 and 350 can be more easily manipulated into their corresponding connection slots.

FIG. 14A further illustrates the first and second arms 330, 332. Arms 330 and 332 can define suction lumens 366 and 368, which are the hollow interior spaces of arms 330 and 332. Arms 330 and 332 also connect the tongue holder body to the cheek retractors of the present disclosure. Arms 330 and 332 can generally have flat top and bottom surfaces that support a patient's teeth should they bite down. Arms 330 and 332 can be sufficiently rigid and strong to withstand the biting pressure of a patient. This is advantageous as it ensures suction lumens 366 and 368 do not collapse, thereby stopping fluid evacuation. A healthcare provider will appreciate the strength and rigidity as the present disclosure can enable continuous fluid extraction during their entire procedures.

FIG. 14B illustrates a side perspective exploded view of the tongue holder 302. Specifically, the first half of 310a was separated from the second half of 310b. As illustrated, slot 343 can be seen as an indentation or concaved portion of the surface of the second half 310b. Accordingly, when secured together with a first half 310a, the inner surface 337 (shown in FIG. 14C) of the first half 310a and the indented or concaved portion of the surface 339 (shown in FIG. 14C) of the second half 310b define slot 343. Slot 343 can extend around the entire structure of the tongue holder body 310 and can connect one or more ports with suction lumens 366 and 368.

FIG. 14B also shows that connection flanges 348 and 350 are disposed on the first half 310a.

FIG. 14C illustrates a bottom perspective exploded view of the tongue holder 302. FIG. 14C shows tubing connections 335 and 334 can also be disposed of on the first half 310a. Receiving slots 349 and 347 can be cutouts on the posterior and anterior ends of the second half 310b. As previously mentioned, keys 341 and 351 can engage with receiving slots 349 and 347 to ensure a secure connection between the first half 310a and the second half 310b.

FIG. 14C also shows channels 336a and 336b, which define a suction lumen 366 (see FIG. 14A). When secured together, channels 336a and 336b can each make up roughly half of the suction lumen 366. The cross-sectional area of suction lumen 366 can correspond to the number and size of the included ports or additional areas that permit the passage of fluid during extraction. To ensure proper suction is maintainable, a manufacturer can vary the location and size of the ports and suction areas while also altering the size and configuration of the slot defined by the first and second half.

FIG. 15A illustrates an embodiment of a second half 410b of a tongue holder. Second half 410b includes an expanded version of slot 343, e.g., slot 443. Slot 443 can extend towards the top section 405 and partially define an added port in zone 411. It should be noted that a manufacturer can alter the dimensions of slot 443 to create added or alternative ports or zones of suction at any point between second half 410b and a first half of the present disclosure.

In another embodiment, a manufacturer can include one or more additional or alternative ports anywhere on a tongue holder of the present disclosure by causing a first or second half to define an alternative or additional aperture. Additionally, the additional or alternative port can be defined by a space between the first and second half of the present disclosure.

FIG. 15A also illustrates how slot 443 is connected to suction lumen 468. Slot 443 is a continuous indentation in the tongue holder material that connects to the suction lumen 468. Healthcare providers will appreciate the additional ports provided when the second half is secured to the first half of the present disclosure. Suction lumens 466 and 468 may also include one or more partitions 481 and gaps 485. To optimize suction distribution within suction lumens 466 and 468, partitions 481 can divide the suction lumens 466 and 468 into two separate chambers, each being a split volume of a suction lumen.

FIG. 15B shows a perspective view of the second half 410b, illustrating the overall shape of partitions 481. The manufacturer can use partition 481 to ensure that suction pressure is maintained more effectively near the front suction ports of a tongue holder. This orientation can also balance the pressure along the length of the suction lumens 466 and 468. In at least one embodiment, partitions 481 and gaps 485 allow for improved suction strength in each suction lumen. The manufacturer can utilize the placement and size of gap 485 to minimize flow obstruction caused by the partitions and to ensure either of the defined chambers can accommodate the flow from any port or zone of suction. In one embodiment, a manufacturer can include no gaps 485. In another embodiment, the manufacturer can include one or more gaps 485 at any location or any interval along the length of partition 481. Gaps 485 can be defined by breaks or openings in or between partitions 481.

The manufacturer can also alter the location of the one or more partitions 481. For example, the second half 410b can have the one or more partitions centrally located or generally centered in each of suction lumens 466 and 468. In an alternative embodiment, such as the one illustrated, partitions 481 can be off-center such that the chambers defined are of different sizes. Additionally, the placement and number of suction holes can be adjusted for optimal fluid or air intake throughout the tube based on the number and location of partitions 481 and gaps 485.

### Additional Terms & Definitions

When a feature of a disclosed dental retractor is described herein with reference to a patient's mouth, including relative component sizes and/or positioning, it will be understood to refer to the anatomy of a standard patient's mouth. A standard patient can be understood as an average American adult of average weight and height, without significant dental/orthodontal conditions, as of the date of filing of this disclosure. The anatomical features of a mouth of such a person are readily obtainable by the person of skill in the art.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, when the terms “about,” “approximately,” “substantially,” or the like are used in conjunction with a stated amount, value, or condition, it may be taken to mean an amount, value or condition that deviates by less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

### EXAMPLE ASPECTS

Clause 1. A dental retractor for use during a dental procedure, the dental retractor comprising: a tongue holder including: a tongue holder body comprising a first half and a second half configured to receive a tongue of a patient, a first arm extending from a first side of the tongue holder body, and a second arm extending from a second side of the tongue holder body opposite the first side; a first mouth retractor and a second mouth retractor, wherein the first mouth retractor is connectable to the first arm of the tongue holder and the second mouth retractor is connectable to the second arm of the tongue holder; and a dental bar connectable to the first mouth retractor and the second mouth retractor; wherein the first half and the second half define one or more suction lumens.
Clause 2. The dental retractor of clause 1, wherein the first half is configured to be connected to a suction system for removing fluid from a patient's mouth.
Clause 3. The dental retractor of clause 1 or 2, wherein when the tongue holder body is disposed about a patient's tongue the first and second arms are configured to extend from the tongue holder laterally beyond a patient's teeth.
Clause 4. The dental retractor of any one of clauses 1 through 3, wherein the first and second arms of the tongue holder each comprise a medial portion extending from the tongue holder body and a tubing connection, which is defined by the first half, laterally connectable to a corresponding medial portion.
Clause 5. The dental retractor of clause 4, wherein the second half is received by the first half to form the first and second arms of the tongue holder each comprising the one or more suction lumens providing fluid communication between the tubing connection and the tongue holder body.
Clause 6. The dental retractor of clause 4 or 5, wherein each tubing connection is oriented at an angle relative to the corresponding medial portion of the first and second arms.
Clause 7. The dental retractor of any one of clauses 4 through 6, wherein the tubing connection comprises a barbed surface for connecting to a suction tube.
Clause 8. The dental retractor of any one of clauses 5 through 7, wherein the tongue holder comprises one or more ports, each port in fluid communication with the suction lumen of the first or second arms.
Clause 9. The dental retractor of clause 8, wherein the one or more ports are disposed on an external surface of the tongue holder body.
Clause 10. The dental retractor of clause 8, wherein the one or more ports are disposed on an external surface of the first or second arms.
Clause 11. The dental retractor of any one of clauses 1 through 10, wherein the first and second arms of the tongue holder each comprise an orientation surface configured to position the tongue holder relative to the surface of a patient's teeth.
Clause 12. The dental retractor of clause 11, wherein a plane of the orientation surface is positioned at an oblique angle relative to a central axis passing through a center of the tongue holder body.
Clause 13. The dental retractor of clause 11 or 12, wherein an anterior end of the tongue holder body is positioned below the first and second arms.
Clause 14. The dental retractor of any one of clauses 1 through 13, wherein the tongue holder is pivotably connectable to the first and second mouth retractors.
Clause 15. The dental retractor of clause 14, wherein the first and second arms of the tongue holder each comprise a corresponding connector flange configured to be received by a connection slot formed in a corresponding mouth retractor.
Clause 16. The dental retractor of any one of clauses 1 through 15, wherein a position of the tongue holder is adjustable in an anterior-to-posterior direction relative to the first and second mouth retractors.
Clause 17. The dental retractor of clause 16, wherein positional adjustment of the tongue holder relative to the mouth retractors in an anterior-to-posterior direction is configured to adjust an amount of space between a posterior surface of the mouth retractor and a patient's teeth.
Clause 18. The dental retractor of any one of clauses 1 through 17, wherein the tongue holder body is adjustable in width.
Clause 19. The dental retractor of any one of clauses 1 through 18, wherein the first half and the second half of the tongue holder body each comprises a left portion, a right portion, and a flexible bridge connecting the left and right portions.
Clause 20. The dental retractor of clause 19, wherein the flexible bridge is disposed at an anterior end of the tongue holder body.
Clause 21. The dental retractor of any one of clauses 1 through 20, wherein an anterior portion of the tongue holder body comprises a slanted surface relative to a central axis of the tongue holder body.
Clause 22. The dental retractor of any one of clauses 1 through 21, wherein the dental bar comprises a plurality of clips configured to secure suction tubing to the dental retractor.
Clause 23. The dental retractor of clause 22, wherein the plurality of clips comprises lateral clips and medial clips, the lateral clips extending in a first direction and the medial clips extending in a second direction opposite the first direction.
Clause 24. The dental retractor of any one of clauses 1 through 23, wherein the first and second mouth retractors each comprise an anterior wall and a posterior wall defining a groove therebetween configured to receive a patient's lips.
Clause 25. The dental retractor of clause 24, wherein the first and second mouth retractors each further comprise a cheek retractor extending from the posterior wall of a corresponding mouth retractor, each cheek retractor configured to pull a patient's cheeks away from a patient's teeth.
Clause 26. The dental retractor of clause 25, wherein each cheek retractor of the first and second mouth retractors extends at an oblique angle from a corresponding posterior wall.
Clause 27. The dental retractor of any one of clauses 1 through 26, wherein the first half comprises one or more anterior keys, wherein the one or more anterior keys are configured to maintain a connection between an anterior end of the first half with an anterior end of the second half.
Clause 28. The dental retractor of any one of clauses 1 through 26, wherein the first half comprises one or more posterior keys, wherein the one or more posterior keys are configured to maintain a connection between a posterior end of the first half with a posterior end of the second half.
Clause 29. The dental retractor of clause 28, wherein an inner posterior key surface of the one or more posterior keys and an inner second half surface of the second half form a level elevation.
Clause 30. The dental retractor of clause 8, wherein the one or more ports are defined by where the first half and the second half abut each other.
Clause 31. The dental retractor of clause 30, wherein the one or more ports are positioned at a posterior end of the tongue holder body.
Clause 32. The dental retractor of clause 30, wherein the one or more ports are positioned medially on the tongue holder body.
Clause 33. The dental retractor of clause 30, wherein the one or more ports are positioned along the first arm and the second arm.
Clause 34. A dental retractor for use during a dental procedure, the dental retractor comprising: a tongue holder configured to remove fluid from a patient's mouth during a dental procedure, the tongue holder comprising: a tongue holder body configured to receive a tongue of a patient defined by a first half that defines one or more apertures and a second half configured to be received by the first half; a first arm extending from a first side of the tongue holder body; and a second arm extending from a second side of the tongue holder body opposite the first side; wherein the tongue holder has one or more suction lumens defined by the first half and the second half.
Clause 35. The dental retractor of clause 34, wherein when the tongue holder body is disposed about a patient's tongue the first and second arms are configured to extend from the tongue holder laterally beyond a patient's teeth.
Clause 36. The dental retractor of clause 34 or 35, wherein the first and second arms of the tongue holder each comprise a medial portion extending from the tongue holder body and a tubing connection laterally connectable to a corresponding medial portion.
Clause 37. The dental retractor of clause 36, wherein the first and second arms of the tongue holder comprise the one or more suction lumen providing fluid communication between the tubing connection and the tongue holder body.
Clause 38. The dental retractor of clause 36 or 37, wherein each tubing connection is oriented at an angle relative to the corresponding medial portion of the first and second arms.
Clause 39. The dental retractor of any one of clauses 36 through 38, wherein the tubing connection comprises a barbed surface for connecting to a suction tube.
Clause 40. The dental retractor of any one of clauses 37 through 39, wherein the tongue holder comprises one or more ports, each port in fluid communication with the suction lumen of the first or second arms.
Clause 41. The dental retractor of clause 40, wherein the one or more ports are disposed on an external surface of the tongue holder body.
Clause 42. The dental retractor of clause 40, wherein the one or more ports are disposed on an external surface of the first or second arms.
Clause 43. The dental retractor of any one of clauses 34 through 42, wherein the first and second arms of the tongue holder each comprise an orientation surface configured to position the tongue holder relative to the surface of a patient's teeth.
Clause 44. The dental retractor of clause 43, wherein a plane of the orientation surface is positioned at an oblique angle relative to a central axis passing through a center of the tongue holder body.
Clause 45. The dental retractor of clause 36 or 44, wherein an anterior end of the tongue holder body is positioned below the first and second arms.
Clause 46. The dental retractor of any one of clauses 34 through 45, wherein the tongue holder body is adjustable in width.
Clause 47. The dental retractor of any one of clauses 34 through 46, wherein the tongue holder body comprises a left portion, a right portion, and a flexible bridge connecting the left and right portions.
Clause 48. The dental retractor of clause 47, wherein the flexible bridge is disposed at an anterior end of the tongue holder body.
Clause 49. The dental retractor of any one of clauses 34 through 48, wherein an anterior portion of the tongue holder body comprises a slanted surface relative to a central axis of the tongue holder body.
Clause 50. The dental retractor of any one of clauses 34 through 49, wherein the second half comprises one or more pins configured to be received by the one or more apertures.
Clause 51. The dental retractor of clause 50, wherein the one or more pins are ultrasonically welded into the one or more apertures.
Clause 52. The dental retractor of clauses 50 or 51, wherein the pins extend from an inner surface of the second half and extend through a portion of the one or more suction lumens.
Clause 53. The dental retractor of any one of clauses 34 through 52, wherein the tongue holder body comprises a slot defined by the first half and the second half that is fluidly connected to the one or more suction lumens.
Clause 54. The dental retractor of clauses 34 through 53, wherein the first arm and the second are constructed from a material exhibiting a SHORE D HARDNESS value of about 70 to about 95.
Clause 55. A dental retractor for use during a dental procedure, the dental retractor comprising: a first mouth retractor comprising: a first cheek retractor; a first connection slot defined by the first cheek retractor; and a first flexion slot defined by the first cheek retractor; and a dental bar selectively connectable to the first mouth retractor.
Clause 56. The dental retractor of clause 55, wherein the dental retractor comprises: a second mouth retractor comprising: a second cheek retractor; a second connection slot defined by the second cheek retractor; and a second flexion slot defined by the second cheek retractor; and wherein the dental bar is connectable to the second mouth retractor.
Clause 57. The dental retractor of clauses 55 or 56, wherein the first connection slot extends into a groove defined by the first mouth retractor.
Clause 58. The dental retractor of clauses 55 through 57, wherein the first mouth retractor comprises a third flexion slot.
Clause 59. The dental retractor of clause 58, wherein the first flexion slot and the third flexion slots flank the first connection slot, allowing a first edge and a second edge of the connection slot to flex.
Clause 60. The dental retractor of clauses 34 through 59, wherein the second half comprises one or more partitions, the one or more partitions defining one or more chambers within one or more suction lumens.
Clause 61. The dental retractor of clause 60, further comprising one or more gaps, the one or more gaps being defined by breaks or openings between the one or more partitions.
Clause 62. The dental retractor of clauses 60 through 61, wherein the one or more chambers have differing dimensions.

1. A dental retractor for use during a dental procedure, the dental retractor comprising:
a tongue holder including:
a tongue holder body comprising a first half and a second half configured to receive a tongue of a patient,
a first arm extending from a first side of the tongue holder body, and
a second arm extending from a second side of the tongue holder body opposite the first side;
a first mouth retractor and a second mouth retractor, wherein the first mouth retractor is connectable to the first arm of the tongue holder and the second mouth retractor is connectable to the second arm of the tongue holder; and
a dental bar connectable to the first mouth retractor and the second mouth retractor;
wherein the first half and the second half define one or more suction lumens.

2. The dental retractor of claim 1, wherein the first half is configured to be connected to a suction system for removing fluid from a patient's mouth.

3. The dental retractor of claim 1, wherein the first and second arms of the tongue holder each comprise a medial portion extending from the tongue holder body and a tubing connection, which is defined by the first half, laterally connectable to a corresponding medial portion.

4. The dental retractor of claim 3, wherein the second half is received by the first half to form the first and second arms of the tongue holder each comprising the one or more suction lumens providing fluid communication between the tubing connection and the tongue holder body.

5. The dental retractor of claim 1, wherein the tongue holder body comprises a slot defined by the first half and the second half that is fluidly connected to the one or more suction lumens.

6. The dental retractor of claim 1, wherein the tongue holder comprises one or more ports, each port in fluid communication with the suction lumen of the first or second arms.

7. The dental retractor of claim 6, wherein the one or more ports are disposed on an external surface of the tongue holder body.

8. The dental retractor of claim 7, wherein the one or more ports are defined by where the first half and the second half abut each other.

9. A dental retractor for use during a dental procedure, the dental retractor comprising:
a tongue holder configured to remove fluid from a patient's mouth during a dental procedure, the tongue holder comprising:
a tongue holder body configured to receive a tongue of a patient defined by a first half that defines one or more apertures and a second half configured to be received by the first half;
a first arm extending from a first side of the tongue holder body; and
a second arm extending from a second side of the tongue holder body opposite the first side;
wherein the tongue holder has one or more suction lumens defined by the first half and the second half.

10. The dental retractor of claim 9, wherein the tongue holder comprises one or more ports, each port in fluid communication with the suction lumen of the first or second arms.

11. The dental retractor of claim 9, wherein the first half comprises one or more anterior keys, wherein the one or more anterior keys are configured to maintain a connection between an anterior end of the first half with an anterior end of the second half.

12. The dental retractor of claim 9, wherein the first half comprises one or more posterior keys, wherein the one or more posterior keys are configured to maintain a connection between a posterior end of the first half with a posterior end of the second half.

13. The dental retractor of claim 9, wherein the second half comprises one or more pins configured to be received by the one or more apertures.

14. The dental retractor of claim 13, wherein the one or more pins are ultrasonically welded into the one or more apertures.

15. The dental retractor of claim 13, wherein the pins extend from an inner surface of the second half and extend through a portion of the one or more suction lumens.

16. The dental retractor of claim 9, wherein the first arm and the second are constructed from a material exhibiting a SHORE D HARDNESS value of about 70 to about 95.

17. A dental retractor for use during a dental procedure, the dental retractor comprising:
a first mouth retractor comprising:
a first cheek retractor;
a first connection slot defined by the first cheek retractor; and
a first flexion slot defined by the first cheek retractor; and
a dental bar selectively connectable to the first mouth retractor.

18. The dental retractor of claim 17, wherein the dental retractor comprises:
a second mouth retractor comprising:
a second cheek retractor;
a second connection slot defined by the second cheek retractor; and
a second flexion slot defined by the second cheek retractor; and
wherein the dental bar is connectable to the second mouth retractor.

19. The dental retractor of claim 17, wherein the first connection slot extends into a groove defined by the first mouth retractor.

20. The dental retractor of claim 19, wherein the first flexion slot and a third flexion slot flank the first connection slot, allowing a first edge and a second edge of the connection slot to flex.
